(19) United States
(12) Patent Application Publication
(10) Pub. No.: US 2002/0085520 A1
(43) Pub. Date: Jul. 4, 2002

(54) Cordless communication system providing optimum spectral usage for wireless networks

(76) Inventors: Uwe Sydon, Duesseldorf (DE); Olaf Dicker, Rees (DE); Juergen Kockmann, Duesseldorf (DE)

Correspondence Address: Siemens Corporation, Intellectual Property Department, 186 Wood Avenue South, Iselin, NJ, 08830, US

(21) Appl. No.: 09/754,905

(22) Filed: Jan. 4, 2001

(51) Int. Cl. H04B 7/216

(52) U.S. Cl. 370/335; 370/342

(57) ABSTRACT

A cordless communication system for use in a wireless network that is capable of providing efficient use of available frequency spectrum within a given physical space is disclosed. The cordless communication system is comprised of a central unit and at least two remote units that are capable of direct communication with each other via wireless connections assigned and coordinated by the central unit.

### BACKGROUND OF THE INVENTION

1. Field of the Invention

The present invention relates generally to cordless communication systems suitable for use in providing wireless networks, and more particularly to a cordless communication system that is capable of providing temporary direct connections between devices of a wireless network, wherein the connections are assigned and coordinated to provide optimum usage of the available frequency spectrum.

2. Description of the Related Art

Cordless communication systems often provide multiple radio frequency (RF) connections for supporting communication between devices such as mobile telephones, computer equipment coupled to cordless data adapters, and the like within a wireless network. Typically, such wireless networks do not require that the cordless communication systems provide extremely high data rate transmission for any single connection within the network. Instead, it is desirable that the cordless communication systems provide moderately high data rate transmission over several connections within a small area thereby allowing communication between several devices at once. Presently, when multiple parallel connections are provided by such cordless communication systems in a wireless network, the data throughput of each connection or link is necessarily reduced to prevent interference between the connections. Consequently, it is desirable that the cordless communication systems optimize usage of the frequency spectrum available to the wireless network.

Many cordless communication systems, particularly those employing widely used transmission standards such as Home RF SWAP (Shared Wireless Access Protocol), Bluetooth, DECT (Digital Enhanced Cordless Telephone), and the like, provide communication between devices within the wireless network via a radio frequency (RF) connection through a central unit such as a base station or the like. Such systems provide more efficient use of the available frequency spectrum, but do not allow direct communication between devices within the wireless network. Other cordless communication systems provide communication between networked devices via a direct radio frequency (RF) connection between the devices without any control by a central unit. However, such systems do not adequately ensure interference free usage of the available frequency spectrum by devices in close proximity to each other. Thus, the overall data rate of connections between such devices in the system is reduced.

Consequently, it is desirable to provide a cordless communication system for a wireless network that is capable of providing direct communication between devices within a wireless network while optimizing usage of the available frequency spectrum within a given physical space.

### SUMMARY OF THE INVENTION

Accordingly, the present invention is directed to a cordless communication system for a wireless network that is capable of providing efficient usage of the frequency spectrum available to the network within a given physical space. In an exemplary embodiment, the cordless communication system includes a central unit and at least two remote units comprised of networked devices. The remote units are capable of communicating with the central unit and with each other via parallel radio frequency (RF) connections. When direct communication between two or more remote units is desired, the central unit assigns a dedicated communication channel to be used by the remote units. In this manner, the communication system allows temporary direct connections between devices within the wireless network that are assigned and coordinated thereby allowing usage of the available frequency spectrum for the wireless network to be optimized.

It is to be understood that both the foregoing general description and the following detailed description are exemplary and explanatory only and are not restrictive of the invention claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous objects and advantages of the present invention may be better understood by those skilled in the art by reference to the accompanying figures in which:

FIG. 1 is a block diagram illustrating a cordless communication system in accordance with an exemplary embodiment of the present invention;

FIG. 2 is a block diagram Further illustrating the cordless communication system of FIG. 1, wherein direct communication has been initiated between two remote units within the system;

FIG. 3 is a block diagram further illustrating the cordless communication system of FIG. 1, wherein direct communication has been initiated between multiple sets of remote units within the system; and

FIG. 4 is a flow diagram illustrating a method for initiating direct communication between two or more remote units of a cordless communication system such as the cordless communication system shown in FIGS. 1 through 3.

### DETAILED DESCRIPTION OF THE INVENTION

The present invention provides a cordless communication system for a wireless network that allows temporary direct connections between devices within the network. These direct connections are assigned and coordinated by a central unit such as a cordless base station or the like for optimizing usage of the frequency spectrum available to the wireless network. Reference will now be made in detail to the presently preferred embodiments of the invention, examples of which are illustrated in the accompanying drawings.

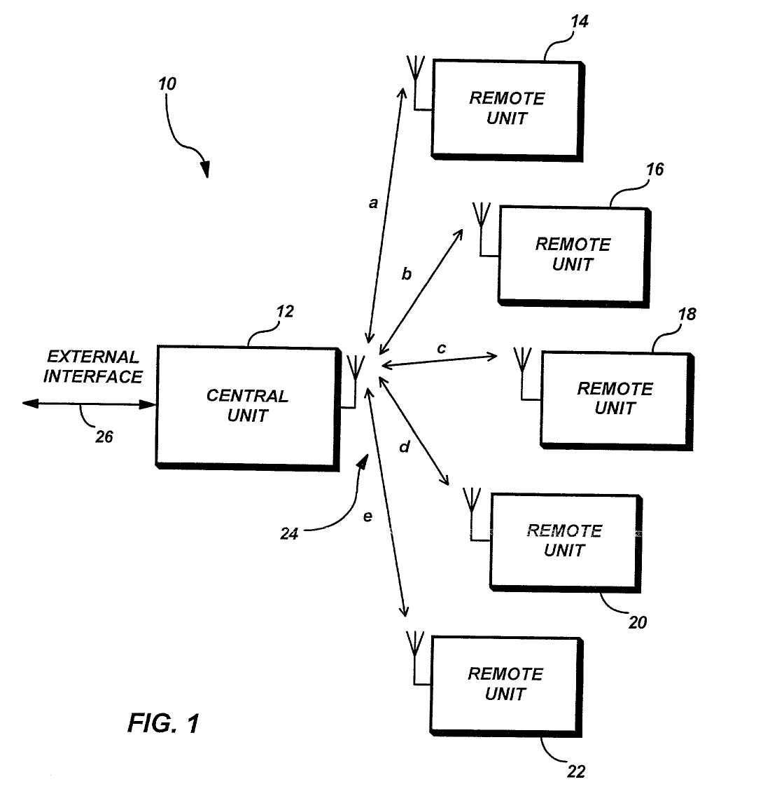

Referring generally to FIG. 1, 2 and 3, a cordless communication system 10 in accordance with an exemplary embodiment of the present invention is described. The cordless communication system 10 includes of a central unit 12 such as a cordless base station, or the like and two or more remote units 14, 16, 18, 20 & 22. Preferably, remote units 14, 16, 18, 20 & 22 may include any of a variety of devices such as cordless mobile telephones, computer systems and peripheral devices coupled to cordless data adapters, and the like, that are capable of radio frequency (RF) communication with the central unit 12 for providing a wireless network 24. In accordance with the present invention, at least one of the remote units 14, 16, 18, 20 & 22 is further capable of direct wireless communication with at least one other remote unit 14, 16, 18, 20 & 22 of the communication system 10.

The central unit 12 may provide a connection to one or more external interfaces 26 for coupling one or more of the remote units 14, 16, 18, 20 & 22 within the wireless network 24 to the outside world. Exemplary external interfaces may include connections to networks such as a public switched telephone network (PSTN), an integrated services digital network (ISDN), the Internet, an Intranet, or the like for communicating with devices outside of the wireless network 24. Thus, the cordless communication system 10 may provide both communication of data and/or voice information between two or more devices within the wireless network 24 and/or between devices in the wireless network 24 and the outside world.

In exemplary embodiments of the present invention, communication system 10 employs spread spectrum technology allowing multiple wireless radio frequency (RF) connections in the same physical space. Further, the radio frequency (RF) connections provided by the communication system 10 may utilize a time division duplex (TDD) technique using a time division multiple access (TDMA) scheme. However, it will be appreciated that the radio frequency (RF) connections may employ transmission schemes other than time division multiple access (TDMA) (e.g., frequency division multiple access (FDMA), code division multiple access (CDMA), or the like) without departing from the scope and spirit of the present invention

The cordless communication system 10 may employ frequency hopping spread spectrum (FHSS) or direct sequence spread spectrum (DSSS) technologies depending on the requirements of the particular application. For example, frequency hopping spread spectrum (FHSS) technology may be employed by cordless communication systems 10 that comply with wireless protocols such as HomeRF SWAP (Shared Wireless Access Protocol), Bluetooth, DECT (Digital Enhanced Cordless Telephone), WDCT (Worldwide Digital Cordless Communications), and the like, while direct sequence spread spectrum (DSSS) technology is employed by cordless communication systems that comply with such standards as WECA WiFi (Wireless Ethernet Compatibility Alliance Wireless Fidelity), and the like. Further, in embodiments of the invention, the cordless communication system 10 may simultaneously comply with two or more wireless networking protocols, for example, to provide a wireless network 24 having both voice and data communication capabilities. In such embodiments, the cordless communication system 10 may thus be capable of employing both frequency hopping spread spectrum (FHSS) and direct sequence spread spectrum (DSSS) technologies to different connections or channels within the wireless network 24 depending on the type of remote units 14, 16; 18, 20 & 22 using those connections.

In exemplary embodiments of the invention, each remote unit 14, 16, 18, 20 & 22 within communication system 10 synchronizes to the central unit 12, which may control all radio frequency (RF) connections within the wireless network 24. When direct communication between one or more remote units 14, 16, 18, 20 & 22 of the communication system 10 is not desired, voice and/or data information communicated between the remote devices 14, 16, 18, 20 & 22 may be relayed through the central unit 12. For instance, as shown in FIG. 1, remote units 14, 16, 18, 20 & 22 are each capable of communication with the central unit 12 via respective radio frequency (RF) communication channels “a”, “b”, “c”, “d” and “e” established and controlled by central unit 12. Wherein a first remote unit, for example. remote unit 14, must communicate with a second remote unit, for example, remote unit 16, the information communicated is first transmitted to the central unit 12 via communication channel “a”. The communication is then transmitted from the central unit 12 to the second remote unit 14 via communication channel “b”. Thus, in an embodiment of the communication system 10 wherein the first and second remote units 14 & 16 are comprised, respectively, of a personal computer and printer each having a cordless data adapter providing access to the wireless network 24, a print job communicated from the personal computer to the printer is transmitted through the central unit 12.

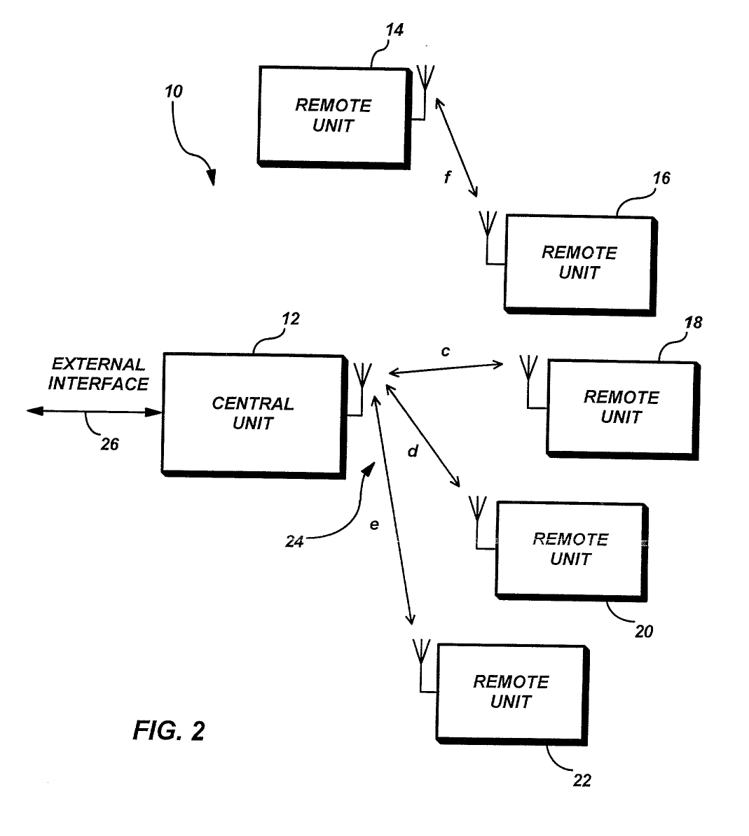

When, on the other hand, it is desired to provide a direct communication link between two or more remote units 14, 16, 18, 20 & 22, the central unit 12 allows specific ones of the remote units 14, 16, 18, 20 & 22 to set up direct communication channels with other remote units 14, 16, 18, 20 & 22 for direct transfer of data and voice information. Preferably, the central unit 12 assigns and coordinates each direct communication channel to minimize interference between the communication channel and existing communication channels within the wireless network 24. For instance, as shown in FIGS. 1 and 2, a first remote unit, such as remote unit 14, may provide a request to the central unit 12, for example, via communication channel “a”, for direct communication with one or more other remote units of the cordless communication system 10, in this case, remote unit 16. In response to this request, the central unit 12 may assign a dedicated communication channel “f” for direct communication between the remote units 14 & 16.

In embodiments of the invention wherein the cordless communication system 10 employs frequency hopping spread spectrum (FHSS) technology, the central unit 12 may assign a specific hopping algorithm or hop sequence to the connection. Similarly, in embodiments wherein the cordless communication system 10 employs direct sequence spread spectrum (DSSS) technology, the central unit 12 may assign a specific spreading code to the connection. Preferably, the central unit 12 assigns hop sequences or spreading codes that will not interfere with other connections in the wireless network. For example, the central unit 12 may assign hop sequences or, alternately, spreading codes. that are orthogonal so that each connection (e.g., channels “a”, “b”, “c”, “d”, “e” and “f”) within the wireless network 24 has minimum impact to other connections within the network 24. In this manner, the central unit 12 maintains full control of the frequency band used by the cordless communication system 10. Thus, several radio frequency connections may be established within the wireless network 24 by the communication system 10, wherein each of the connections has substantially the full system data rate.

As shown in FIG. 2, once the central unit 12 initiates the dedicated wireless connection or channel “f” between the first remote unit 14 and the second remote unit 16, the remote units 14 & 16 may then be allowed to communicate directly, i.e., the information communicated is not communicated through the central unit 12. The first or “requesting” unit 14 functions as a “temporary central unit” wherein the second remote unit 16 synchronizes to the first unit 14. Thus, in an embodiment of the communication system 10 wherein the first and second remote units 14 & 16 are comprised respectively of a personal computer and printer each having a cordless data adapter providing access to the wireless network 24, a print job communicated from the personal computer to the printer would be communicated directly with the printer without first going through the central unit 12.

When communication between the first and second remote units 14 & 16 ceases, the first remote unit 14, or alternately, the second remote unit 16, may provide an indication to the central unit 12 that direct communication between the remote units 14 & 16 has ended. The direct communication channel “f” between the first remote unit 14 and the second remote unit 16 may then be terminated, and its assigned hop sequence, or, alternately, spreading code made available for use by another connection within the wireless network 24. The first remote unit 14 and second remote unit 16 may then return to their original state and again synchronize to the central unit 12 as shown in FIG. 1.

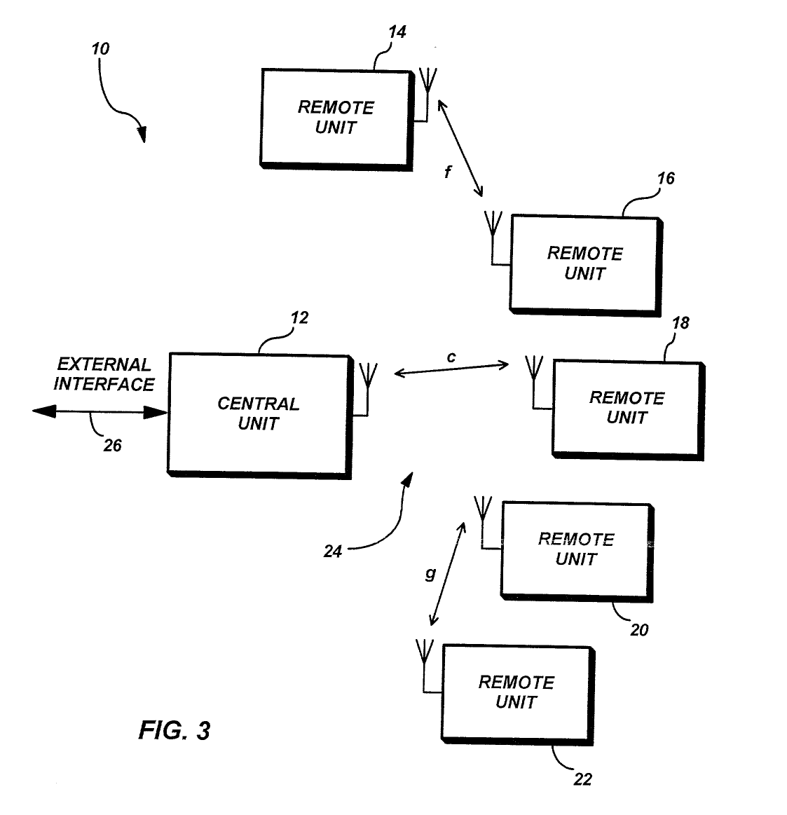

In exemplary embodiments of the invention, the cordless communication system 10 may be capable of providing direct communication links between multiple groups of remote units 14, 16, 18, 20 & 22 within the wireless network 24. Thus, as shown in FIGS. 1 and 3, a third remote unit, such as remote unit 20, may provide a request to the central unit 12, for example, via communication channel “d”, for direct communication with a fourth remote unit, for example, remote unit 22. In response to this request, the central unit 12 may assign a second dedicated communication channel, for example, channel “g”, for direct communication between the remote units 20 & 22 in addition to the communication channel “f” assigned to remote units 14 & 16. Thus, in an embodiment of the communication system 10 wherein the first and second remote units 14 & 16 are comprised respectively of a personal computer and printer each having a cordless data adapter providing access to the wireless network 24, coupled by dedicated communication channel “f” to communicate a print job, a second communication channel “g” may simultaneously be established between, for example, two cordless telephones to enable voice communication between users of the wireless network 24.

The central unit 12 preferably assigns a hop sequence or, alternately, a spreading code to this channel that will not interfere with other connections in the wireless network. For example, the central unit 12 may assign hop sequence or, alternately, a spreading code, that is orthogonal to those assigned to other channels so that each connection (e.g., channels “a”, “b”, “c”, “d”, “e”, “f”and “g”) within the wireless network 24 may have minimum impact to other connections within the network 24. Further, the central unit 12 may be capable of reusing assigned channels provided the physical distance separating the remote units 14, 16, 18, 20 & 22 communicating via the reused channels is sufficient to minimize or prevent interference. Thus, as shown in FIG. 3, wherein remote units 14 & 16 and remote units 20 & 22 are determined to be separated by a sufficient distance to prevent interference, the central unit 12 may assign a common hop sequence or spreading code to channels “f” and “g” thus reusing those channels. In this manner, multiple parallel radio frequency (RF) connections may be established between remote units 14, 16, 18, 20 & 22 of the wireless network 24, wherein each of the connections has substantially the full system data rate.

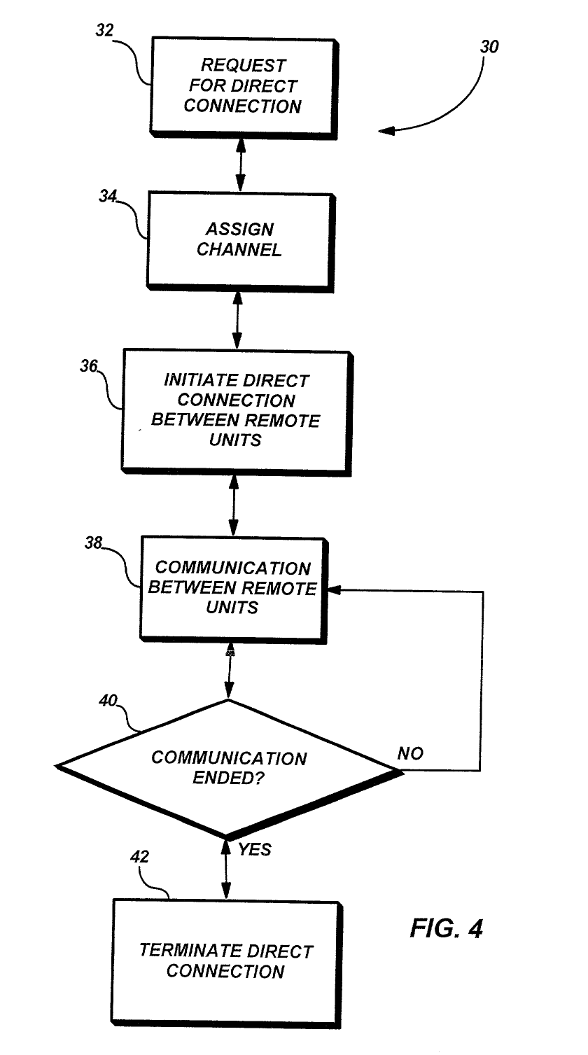

Turning now to FIG. 4, a method 30 for providing temporary direct communication between two or more remote units of a cordless communication system, such as the cordless communication system 10 shown in FIGS. 1 through 3, is described. In the exemplary embodiment shown, the method 30 is initiated when a first remote unit of the cordless communication system provides a request to the central unit of the cordless communication system for direct communication with a second remote unit at step 32. The central unit, upon receiving the request from the first remote unit, assigns a dedicated communication channel for direct communication between the first remote unit and the second remote unit at step 34. For instance, as discussed above, the central unit may assign a specific hopping algorithm or hop sequence, or, alternately, a specific spreading code for the dedicated communication channel, depending on whether frequency hopping spread spectrum (FHSS) or direct sequence spread spectrum (DSSS) technology is being used. The central unit then initiates a dedicated wireless connection between the first remote unit and the second remote unit at step 36. The first or “requesting” unit now functions as a “temporary central unit” to the second remote unit wherein the second remote unit synchronizes to the first unit. The remote units may then communicate directly with each other at step 38 via the established communication channel or link which may have substantially the full system data rate. The central unit then waits for an indication that the remote units have ceased direct communication at step 40. For instance, when communication between the first and second remote units has ended, either or both of the first remote unit and the second remote unit may provide an indication to the central unit that direct communication has ended and the dedicated channel between the remote units is no longer required. The direct connection between the first remote unit and the second remote unit may then be terminated at step 42, whereupon the first remote unit and second remote unit return to their original state and again synchronize to the central unit.

In exemplary embodiments, the various steps of method 30 may be implemented as sets of instructions such as software or firmware implemented on the central unit and remote units of a communication system such as communication system 10 shown in FIGS. 1, 2 and 3. It is understood that the specific order or hierarchies of steps in the method 30 are examples of exemplary approaches. Based upon design preferences, it is understood that the specific order or hierarchy of steps in the method can be rearranged while remaining within the scope of the present invention. The attached method claims present elements of the various steps in a sample order, and are not meant to be limited to the specific order or hierarchy presented.

It is believed that the cordless communication system of the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A cordless communication system, comprising:
a central unit; and
at least two remote units, said at least two remote units being capable of radio frequency communication with said central unit and other of said at least two remote units;
wherein said central unit is capable of assigning a dedicated communication channel for enabling direct communication between selected ones of said at least two remote units.

2. The cordless communication system of claim 1, wherein each of said at least two remote units is further capable of communication with another of said at least two remote units via a radio frequency connection relayed through said central unit.

3. The cordless communication system of claim 2, wherein each of said remote units synchronizes to said central unit.

4. The cordless communication system of claim 1, wherein a first of said at least two remote units is capable of providing a request to said central unit for a direct connection with a second of said at least two remote units.

5. The cordless communication system of claim 4, wherein upon receiving a request from said first remote unit, said central unit assigns a dedicated communication channel for enabling direct communication between said first and second remote units, said second remote unit synchronizing to said first remote unit.

6. The cordless communication system of claim 1, wherein said radio communication comprises time division duplex connections utilizing a time division multiple access (TDMA) scheme.

7. The cordless communication system of claim 1, wherein said radio communication comprises a frequency hopping spread spectrum (FHSS) scheme and said central unit assigns the dedicated communication channel by assigning a specific hop sequence to selected ones of said at least two remote units.

8. The cordless communication system of claim 1, wherein said radio frequency communication comprises direct sequence spread spectrum (DSSS) scheme and said central unit assigns said dedicated communication channel by assigning a specific spreading code to selected ones of said at least two remote units.

9. The cordless communication system of claim 1, wherein said central unit provides an interface for interfacing the communication system with a network.

10. The cordless communication system of claim 9, wherein the network comprises at least one of a public switched telephone network (PSTN), an integrated services digital network (ISDN), the Internet, and an Intranet.

11. A cordless communication system, comprising:
a central unit; and
at least two remote units capable of radio frequency communication with said central unit;
wherein each of said at least two remote units is capable of communication with another of said at least two remote units via a radio frequency connection relayed through said central unit; and
wherein a first of said at least two remote units is further capable of communication with a second of said at least two remote units via a dedicated radio frequency connection assigned by said central unit for enabling direct communication between said first remote unit and said second remote unit.

12. The cordless communication system of claim 11, wherein each of said remote units synchronizes to said central unit.

13. The cordless communication system of claim 11, wherein a first of said at least two remote units is capable of providing a request to said central unit for a direct connection with a second of said at least two remote units.

14. The cordless communication system of claim 13, wherein upon receiving a request from said first remote unit, said central unit assigns a dedicated communication channel for enabling direct communication between said first and second remote units, said second remote unit synchronizing to said first remote unit.

15. The cordless communication system of claim 11, wherein said radio communication comprises time division duplex connections utilizing a time division multiple access (TDMA) scheme.

16. The cordless communication system of claim 11, wherein said radio communication comprises a frequency hopping spread spectrum (FHSS) scheme and said central unit assigns the dedicated communication channel by assigning a specific hop sequence to selected ones of said at least two remote units.

17. The cordless communication system of claim 11, wherein said radio frequency communication comprises direct sequence spread spectrum (DSSS) scheme and said central unit assigns said dedicated communication channel by assigning a specific spreading code to selected ones of said at least two remote units.

18. The cordless communication system of claim 11, wherein said central unit provides an interface for interfacing the communication system with a network.

19. The cordless communication system of claim 18, wherein the network comprises at least one of a public switched telephone network (PSTN), an integrated services digital network (ISDN), the Internet, and an Intranet.

20. A method for providing direct radio frequency communication between remote units in a cordless communication system, comprising:
providing a request to a central unit for direct radio frequency communication between a first remote unit and a second remote unit; and
initiating a direct connection between the first remote unit and the second remote unit via a dedicated communication channel assigned to the first remote unit and the second remote unit by the central unit.

21. The method of claim 20, further comprising:
determining that communication between the first remote unit and the second remote unit has ended; and
terminating the direct connection between the first remote unit and the second remote unit.

22. The method of claim 21, wherein determining that communication between the first remote unit and the second remote unit has ended comprises providing an indication to the central unit that communication between the first remote unit and the second remote unit has ended.

23. The method of claim 21, wherein initiating a direct connection between the first remote unit and the second remote unit comprises assigning the dedicated communication channel.

24. The method of claim 23, wherein radio communication within the cordless communication system comprises a frequency hopping spread spectrum (FHSS) scheme and assigning the dedicated communication channel comprises assigning a specific hop sequence to the first and second remote units.

25. The method of claim 23, wherein radio frequency communication within the cordless communication system comprises direct sequence spread spectrum (DSSS) scheme and assigning the dedicated communication channel comprises assigning a specific spreading code to the first and second remote units.
